(19) United States
(12) Patent Application Publication
(10) Pub. No.: US 2016/0225277 A1
(43) Pub. Date: Aug. 4, 2016

(54) FLIGHT SIMULATOR

(71) Applicant: X-COPTER, LLC, Prescott, AZ (US)

(72) Inventors: TIMOTHY BELLIS, DEWEY, AZ (US); KELTON ROCHELLE, CHINO VALLEY, AZ (US)

(73) Assignee: X-COPTER, LLC, PRESCOTT, AZ (US)

(21) Appl. No.: 15/010,771

(22) Filed: Jan. 29, 2016

Related U.S. Application Data
(60) Provisional application No. 62/109,461, filed on Jan. 29, 2015.

(51) Int. Cl. G09B 9/30; G09B 5/02

(52) U.S. Cl. CPC G09B 9/30; G09B 5/02

(57) ABSTRACT

The flight simulator system includes a varied voltage linear transducer sensor interfacing with a moving axis to enhance precision position tracking. The varied voltage linear transducer sensor may be a Hall Effect sensor. The moving axis may be located at one or more of a cyclic assembly, a collective assembly and/or an anti-torque pedal. At the collective assembly, a first of the varied voltage linear transducer sensor is included on a first axis (e.g., pitch) and a second of the varied voltage linear transducer sensor is included on a second axis (e.g., roll). The varied voltage linear transducer sensor interfaces with one or more axial position in the simulator controls. The system may further comprise an input controller configured to translate output from the varied voltage linear transducer sensor from analog to digital.

### CROSS REFERENCE TO RELATED APPLICATIONS

This application claims priority to and the benefit of U.S. Provisional Ser. No. 62/109,461 filed on Jan. 29, 2015 and entitled “Improved Flight Simulator,” which is incorporated by reference herein in its entirety for all purposes.

### FIELD

The present disclosure generally relates to flight simulators, and more particularly, to the use of a Hall Effect Sensor and input controller to improve durability and precision control.

### BACKGROUND

A flight simulator re-creates the experience of flying an aircraft in a safe environment to help with the training of pilots in various situations. Flight simulators may also help with the design and development of the aircraft, analysis of aircraft characteristics and control handling qualities. A flight simulator may provide the user with experiences for interacting with flight controls, the effects of other aircraft systems, and how the aircraft reacts to external factors (e.g., air density, turbulence, wind shear, cloud cover, precipitation, etc).

Some of the original flight simulators included a pneumatic motion platform driven by inflatable bellows which provided pitch (nose up and down) and roll (wing up or down) cues. An electric motor rotated the platform to provide yaw (nose left and right) cues. The prior art designs included commonly used sensors (variable resistor potentiometers), but such sensors turned out to be inefficient and very expendable (e.g., the sensors would wear out). The prior art systems also included undesirable contact bounce. A need exists for an improved flight simulator that minimizes contact bounce, while increasing fluidity and precision control.

### SUMMARY

The flight simulator system includes a varied voltage linear transducer sensor interfacing with a moving axis to enhance precision position tracking. The varied voltage linear transducer sensor may be a Hall Effect sensor. The moving axis may be located at one or more of a cyclic assembly, a collective assembly and/or an anti-torque pedal. At the collective assembly, a first of the varied voltage linear transducer sensor is included on a first axis (e.g., pitch) and a second of the varied voltage linear transducer sensor is included on a second axis (e.g., roll). The varied voltage linear transducer sensor interfaces with one or more axial position in the simulator controls. The moving axis may include about zero degrees to ninety degrees of motion. The varied voltage linear transducer sensor includes an output resolution for controlling simulated aircraft with precision. The varied voltage linear transducer sensor includes an input voltage of the window. The varied voltage linear transducer sensor includes degrees of motion for at least partial range of motion of controls. An input controller may be included to decode a signal from the varied voltage linear transducer sensor, to a signal readable by software. The system may further comprise an input controller configured to translate output from the varied voltage linear transducer sensor from analog to digital.

### BRIEF DESCRIPTION OF THE DRAWINGS

The features and advantages of the present disclosure will become more apparent from the detailed description set forth below when taken in conjunction with the drawings.

FIG. 1 shows an overview of the major components of the simulator, in accordance with various embodiments.

FIG. 2 shows a more detailed view of the HES on the collective, in accordance with various embodiments.

FIG. 3 shows a more detailed view of the HES on the cyclic, in accordance with various embodiments.

FIG. 4 shows a more detailed view of the HES on the foot pedals, in accordance with various embodiments.

### DETAILED DESCRIPTION

The detailed description of various embodiments herein makes reference to the accompanying drawings and pictures, which show various embodiments by way of illustration. While the various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

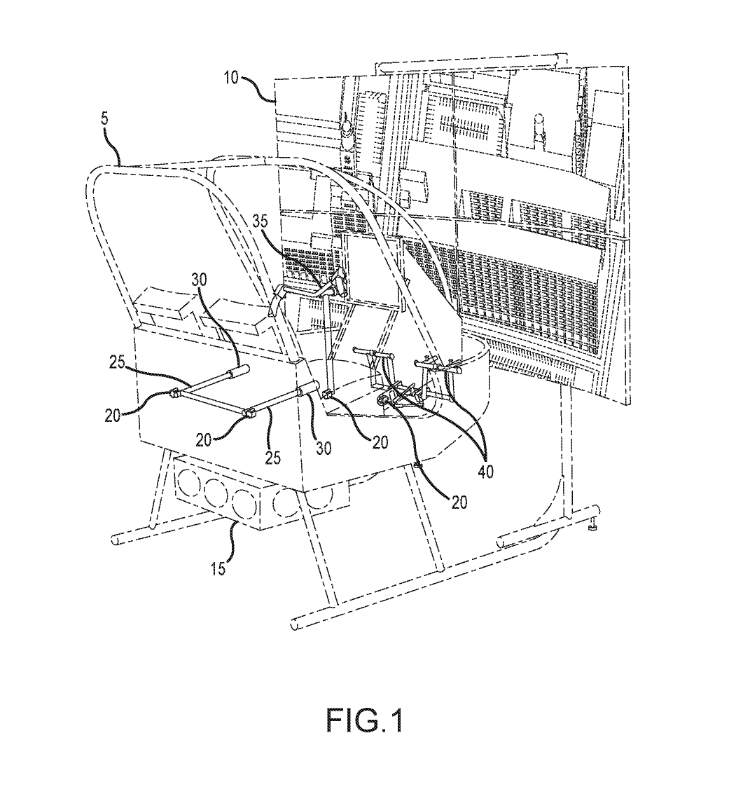

As set forth in FIG. 1, the system may include various components that facilitate precision position tracking. In various embodiments, the system includes a flight simulator. The flight simulator may include, for example, a cab 5, screens 10, wiring, electronics, a computer 15, left collective 25, right collective 25, left throttle 30, right throttle 30, collective 25 HES 20, cyclic 35 assembly, cyclic 35 HES 20, pedal blocks 40 and pedal HES 20.

The system may include certain requirements, interfaces, control boards, etc. to enable the varied voltage linear transducer sensor (e.g., Hall Effect sensor (HES 20)) to suitably operate. In particular, in various embodiments, the system includes technical details such as the output resolution of HES 20 needed to control simulated aircraft with precision, the input voltage of the HES 20 window, the degrees of motion for partial or full range of motion of the controls, hardware (e.g., input controller) to decode the HES 20 signal to a signal readable by software, software to decode the data from the HES 20, and suitable wiring to interface and carry signals to/from various components. For example, the output resolution of the HES 20 may be about 100,000 step resolution. Such a resolution helps to accomplish the control-ability of a helicopter, due to the sensitivity of hovering and other maneuvers. The input voltage of the HES 20 window includes about a 0-5 volts input range. The degrees of motion for the full range of motion produced by the controls may be about 90 degrees of motion. The HES 20 works for the simulator controls, and in various embodiments, the HES 20 may be integrated into the design of the controls.

HES 20 units include much increased fluidity and precision control. The HES 20 is not impacted (or minimal impact) by contact bounce, due to their solid state mechanics. In various embodiments, any portion or all of the HES 20 assembly is encapsulated in epoxy, further protecting it from environmental factors. The HES 20 may interface with any components in the simulator, such as anywhere there is a moving axis in need of precision position tracking in lieu of using an unreliable mechanical linear potentiometer. For example, an HES 20 may be used for precise measurement of any axial position in the simulator controls including the cyclic 35, collective 25 and anti-torque pedals 40. This reduces the maintenance of the controls (in some cases no maintenance is needed) and greatly increases the reliability and MTBF of the flight simulator controls. Using the HES 20 in the controls enables a control design that simulates the controls of real helicopters with accurate precision, thus enhancing the realism and sensory input to the user.

Each of the HES 20 units work by emitting a magnetic field (MF). When an object (often a magnet) passes through or interrupts said MF, the field disruption data is calculated as motion input. The HES 20 units contain a gear with varying numbers (and positioning) of teeth also known as an encoder wheel. When a specific tooth or set of teeth pass by (or through) the EF (notated by a change in the normal teeth pattern), that measurement input is converted into movement data, which is then relayed to a 12-bit (4096 step) analog input controller device connected to the simulation control computer 15 via USB. Depending on the complexity of the HES 20, the output may be analog or digital. If the output is analog, the HES 20 may be interfaced into an analog-to-digital (A/D) converter and then to the computer 15. A converter board may be included to obtain the analog signal from the HES 20 and convert it to a digital signal. If the output is digital, the system may include one or more of many different interface techniques. The HES 20 may interface directly to the computer 15 if the sensor offers a compatible serial format (e.g., USB or RS232) or a separate interface to convert the digital format may be included. The HES 20 may have a different physical interface (plug) than the converter device or computer 15. As such, the system may include a cable to interface the devices.

HES 20 units are included in this system due to, for example, their fluidity and precision control. HES 20 units are not affected by (or little impact by) contact bounce due to their solid state mechanics. Development of the HES 20 technology has enabled the use of HES 20 anywhere there is a moving axis in need of precision position tracking in lieu of using an unreliable mechanical linear potentiometer. This reduces the maintenance of the controls to effectively none greatly increasing the reliability and MTBF of our flight simulator controls. Using the HES 20 in the controls has enabled a control design that simulates the controls of any aircraft (e.g., helicopters) with accurate precision, thus enhancing the realism and sensory input to the user.

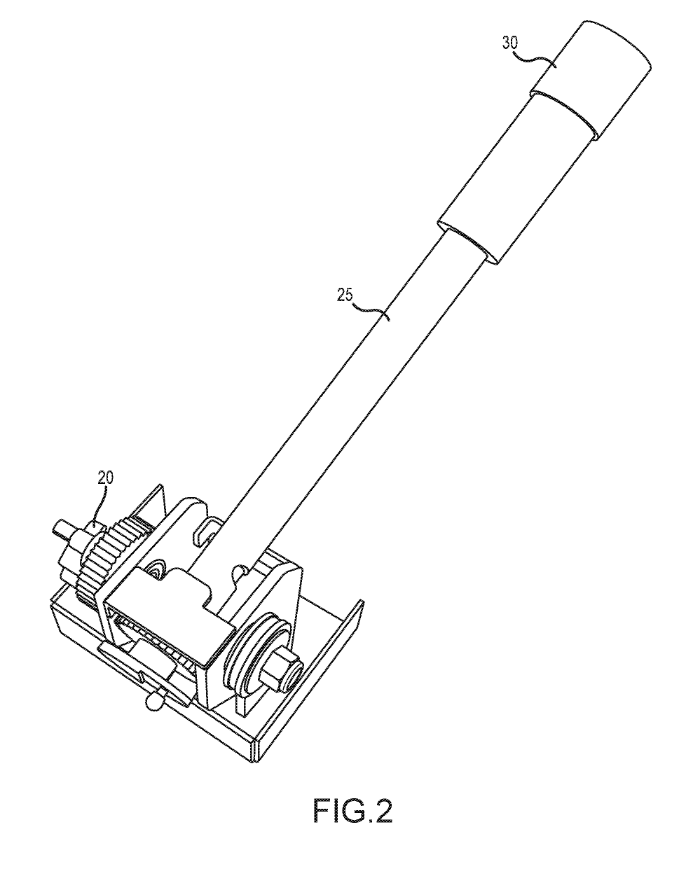

With respect to FIG. 2, the collective 25 includes an HES 20. The wiring and electronics allow communication and/or interfacing between the Hall Effect Sensor and the input controller. The input controller may be any software and/or hardware suitably configured to translate the HES 20 output from analog to digital data for the computer 15. The input controller may be connected to the simulation control computer 15 via USB. In various embodiments, the input controller device reads the hardware output. The input controller may decode the signal from the Hall Effect Sensor into a format which the custom software is able to read and/or translate to movement of the simulated aircraft on the simulator. In various embodiments, the input controller may be contained in the HES 20 itself as some have digital output. The input controller may reside inside the computer 15 directly on an internal bus (e.g., PCMCIA, ISA, PCI, PCIe). The input controller may be a module separate from the controller and HES 20 in which case the input controller could be mounted anywhere in the simulator. The input controller may interface with the computer 15 via an external bus (e.g., USB, CANbus, ARINC429, RS232/422/485 or other digital bus).

In various embodiments, the collective 25 may be comprised of two major components and the simulator may include both sets. In various embodiments, the person in charge (PIC) collective 25 assembly may be located between both seats at the back of the cab 5. The second in charge (SIC) collective 25 assembly may be located to the left of the leftmost seat, also at the back of the cab 5. Two interconnecting links may connect the movement of each device. A tube (e.g., square tube) may connect the vertical motion of the collective 25 input. A threaded rod with fittings may connect the throttle 30 input via flanges on each end. Inside the main collective 25, plastic gears are driven off the rotating axis of the collective 25 to the HES 20 for collective input. A second throttle 30 sensor may also be driven by gears (e.g., plastic gears) attached to the rotating shaft of the throttle 30 assembly. A friction assembly may interface with the collective 25 rotating shaft opposite the collective 25 input sensor. At the end of the collective 25 arm, a rotating throttle 30 grip assembly may interface with the throttle 30 shaft. Capped at the end of the throttle 30 grip may be a housing which mounts two components. The components may include one toggle and one momentary switch. Inside the SIC collective 25 assembly, the collective 25 arm is connected to the rotating collective 25 input from the PIC collective 25 assembly via a fitting (e.g., square-ended fitting). A flange on the end of the throttle 30 shaft may correlate throttle 30 input between the two collective 25 assemblies. The collective 25 shafts may be supported by bearing assemblies, and enclosed with protective covers.

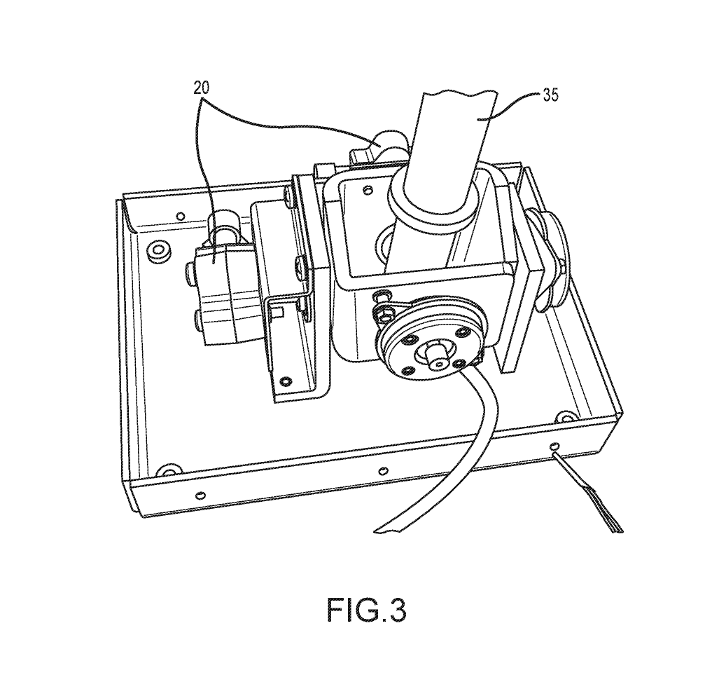

With respect to FIG. 3, the cyclic 35 includes two HES 20. The two HES 20 operate in conjunction with the two axis, namely the pitch (axis front to back to make aircraft go up and down) and roll (banking and turning, left and right). In various embodiments, the cyclic's 35 basic operation may include the T-bar design that pivots around a universal joint attached to a vertical shaft at the top of which, a single axis pivot allows a T-shaped handle to sway from one pilot to another. In various embodiments, the basic construction of the cyclic 35 may include a base plate that is attached to the floor of the simulator between both pilots, near the knees. At the middle of the base plate, a universal joint is housed to allow for a pitch and roll motion. At the base of the cyclic 35 assembly, there are two HES 20 units that may interface and/or help control the cyclic 35 assembly. In various embodiments, the HES 20 units may be attached to each axis on the universal assembly. In various embodiments, a single vertical shaft extending up from the universal assembly supplies input. At the top of the vertical shaft, another longitudinal axis pivot connects the T-bar, which allows the handles to rest comfortably in either pilot's lap.

On the right side of the cyclic 35 T-bar, a vertical handle exists with four (4) buttons for avionics, communication, and aircraft operation, namely: two (2) aft, one (1) forward, one (1) on the right end of the T-bar, as well as one (1) aft toggle switch. A two-stage momentary switch is typically used as the forward button, but in various embodiments, the system may instead use a single-stage momentary switch as the forward button.

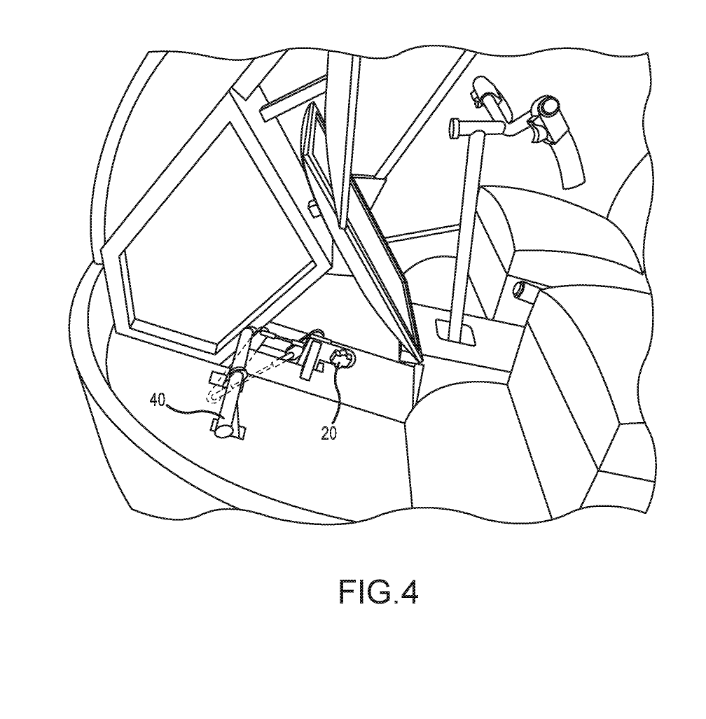

With respect to FIG. 4, exemplary pedal blocks 40 are shown. Leverage from the pedals 40 may bend certain parts. In various embodiments, anti-torque pedals 40 may include a flange, along with heims and clevices, on both sides to avoid the rotating force, and avoid the bending. In various embodiments, the anti-torque pedals 40 may be mounted below the floor panel on the forward section of the cab 5. The pedals 40 may be divided into two complete assemblies, similar except for, in various embodiments, the installation of a HES 20 on one of the assemblies (e.g., in the right (PIC) assembly). A cross linkage between the two assemblies with a right angle ball joint on either end link the movement of both assemblies together to produce the same movement on each side. Each pedal assembly may be comprised of two vertical tubes, at the top of which, a removable/adjustable foot pedal rest may located. The seat typically does not move in a real helicopter. As such, in various embodiments, the system includes removable/adjustable pedals 40 to help a shorter or taller user.

Certain pedal assembly components are above the floor to allow for foot control input for yaw in the simulator. Below the floor, at the bottom of the vertical tubes is a housing that contains the HES 20, heim links, bearings, opposing T-link, supports and a cover. A horizontal tube may be at the bottom of the vertical tubes of the pedals 40, and the horizontal tube may be suspended by bearings. These horizontal lateral tubes may also be connected to clevices that accept a heim. The heim links may be connected to the opposing T-link that produces the inverting motion of the pedals 40 (as one moves one direction the other moves in the opposite direction proportionately). The input for the HES 20 may be fitted to the end of the rotating shaft of the opposing T-link. In various embodiments, the arm may connect the pedal blocks 40 to the sensor arm underneath the simulator nose, then up through the floor to the HES 20.

In various embodiments, the system may include additional features and functions. For example, the system may include a unique modular design of certain components. Such components can be more easily fixed or replaced. In various embodiments, a base plate may be added to the floor of the simulator between both pilots, to help to form the basis for the modular design.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS® NT®, WINDOWS® 95/98/2000®, WINDOWS® XP®, WINDOWS® Vista®, WINDOWS® 7®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments may include one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. THES 20e signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. The computer program products provide software to the computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. The computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® NT®, 95/98/2000/CE/Mobile, OS2, UNIX®, LINUX®, SOLARIS®, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE® talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collective 25ly suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical web site might include, in addition to standard HTML documents, various forms, JAVA APPLE® ts, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQTM (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A flight simulator system having a varied voltage linear transducer sensor interfacing with a moving axis to enhance precision position tracking.

2. The system of claim 1, wherein the moving axis is located at a cyclic assembly.

3. The system of claim 1, wherein the moving axis is located at a collective assembly.

4. The system of claim 1, wherein the moving axis is located at an anti-torque pedal.

5. The system of claim 1, wherein the moving axis is located at a collective assembly and a first of the varied voltage linear transducer sensor is included on a first axis and a second of the varied voltage linear transducer sensor is included on a second axis.

6. The system of claim 1, wherein the moving axis is located at a collective assembly and a first of the varied voltage linear transducer sensor is included on a pitch axis and a second of the varied voltage linear transducer sensor is included on a roll axis.

7. The system of claim 1, wherein the varied voltage linear transducer sensor is a Hall Effect sensor.

8. The system of claim 1, wherein the varied voltage linear transducer sensor interfaces with one or more axial position in the simulator controls.

9. The system of claim 1, wherein the moving axis includes about zero degrees to ninety degrees of motion.

10. The system of claim 1, wherein the varied voltage linear transducer sensor includes an output resolution for controlling simulated aircraft with precision.

11. The system of claim 1, wherein the varied voltage linear transducer sensor includes an input voltage of the window.

12. The system of claim 1, wherein the varied voltage linear transducer sensor includes degrees of motion for at least partial range of motion of controls

13. The system of claim 1, further comprising an input controller to decode a signal from the varied voltage linear transducer sensor.

14. The system of claim 1, further comprising an input controller to decode a signal from the varied voltage linear transducer sensor, to a signal readable by software.

15. The system of claim 1, wherein an output resolution of the varied voltage linear transducer sensor is about 100,000 step resolution.

16. The system of claim 1, wherein an input voltage of the varied voltage linear transducer sensor is about a 0-5 volts input range.

17. The system of claim 1, wherein the varied voltage linear transducer sensor is encapsulated in epoxy.

18. The system of claim 1, further comprising an input controller configured to translate output from the varied voltage linear transducer sensor from analog to digital.
